(19) United States
(12) Patent Application Publication
(10) Pub. No.: US 2020/0388199 A1
(43) Pub. Date: Dec. 10, 2020

(54) FLAG MOUNT ASSEMBLY

(71) Applicant: Theodore J. Hammerle, Ankeny, IA (US)

(72) Inventor: Theodore J. Hammerle, Ankeny, IA (US)

(21) Appl. No.: 16/893,960

(22) Filed: Jun. 5, 2020

Related U.S. Application Data
(60) Provisional application No. 62/858,400, filed on Jun. 7, 2019.

(51) Int. Cl. G09F 17/00; B60R 13/00

(52) U.S. Cl. CPC G09F 17/00; G09F 2017/0075; B60R 13/00

(57) ABSTRACT

The present invention relates to a flag mount assembly to mount a flag to a vehicle. The flag mount assembly has a cylinder that receives the flag pole of a flag. One or more flag securing members selectively secure a position of the flag pole. One or more vehicle mounting brackets attach the flag mount assembly to the vehicle. An auxiliary tab also extends from the cylinder to allow an auxiliary, such as trail flag, to be mounted. The arrangement of the flag mount assembly allows for reversal and positioning and connection of the flag mount assembly on both or either the driver side or passenger side of the vehicle.

### CROSS REFERENCE TO RELATED APPLICATION

This application claims the benefit of the priority of U.S. Provisional Application No. 62/858,400 filed on Jun. 7, 2019, the contents of these applications are hereby incorporated by reference in their entirety.

### BACKGROUND OF THE INVENTION

This invention is directed towards a mount assembly. More specifically, and without limitation, this invention relates to a flag mount assembly and system.

Flag mount assemblies are known in the art, which allow an individual to display a flag from their vehicle. With particular regard to sports utility vehicles (SUVs), such as the Jeep® Wrangler JL or JK, and sports activity vehicles (SAVs), flag mount assemblies are either attached to a hitch of a vehicle or a tire carrier. Existing flag mount assemblies, however, suffer from a number of deficiencies.

Flag mount assemblies that are attached to the hitch of a vehicle are problematic as they prevent the rear door of the vehicle to open as the rear door would contact the flag mount assembly, which could result in damage to the vehicle and the flag mount assemblies. To address this problem, some flag mount assemblies are attached to the tire carrier so that the rear door to which the tire carrier is attached can still be opened. However, flag mount assemblies attached to the tire carrier are not capable of holding a conventionally sized flag, which are conventionally three feet by five feet or greater.

Other flag mount assemblies that attach to the tire carrier position the flag overtop the spare tire such that the flag drapes over the tire when the vehicle is not moving, which can be viewed as disrespectful depending on the nature of the flag, e.g., the American flag. Other flag mount assemblies attach to the spare tire, which can also inhibit the aesthetic of the vehicle. Both of these centrally positioned flag mount assemblies only permit a single flag to be presented from the rear of the vehicle. Additionally, flag mount assemblies that attach to the spare tire inhibit the use of the spare tire as the flag mount assembly must be removed prior to using the spare tire and must then be reattached to the damage tire being stored on the tire carrier thereafter.

Thus it is a primary objective of this invention to provide a flag mount assembly and system that improves upon the art.

Another objective of this invention is to provide a flag mount assembly and system that can mount and present a conventionally sized flag.

Yet another objective of this invention is to provide a flag mount assembly and system that permits multiple flags to be presented.

Another objective of this invention is to provide a flag mount assembly and system that permits flags to be selectively presented on either a driver's side or a passenger's side of a vehicle.

Yet another objective of this invention is to provide a flag mount assembly and system that is reversible.

Another objective of this invention is to provide a flag mount assembly and system that is durable and easy to use.

These and other objectives, features, and advantages of the invention will become apparent from the specification and claims.

### SUMMARY OF THE INVENTION

In general, the present invention relates to a flag mount assembly for a vehicle that allows a conventionally sized flag to be mounted to a vehicle while not occupying the hitch of the vehicle or preventing the rear of the vehicle to be opened. The flag mount assembly includes a cylinder that receives a flag pole of the flag. One or more flag securing members are selectively received in the cylinder to apply force to the flag pole to maintain its position.

The present invention also includes one or more vehicle mounting brackets, which in some embodiments have a triangular profile. The vehicle mounting brackets extend away from the cylinder and have an opening that is used along with a spacer to secure the flag mount assembly to a vehicle, and in particular embodiments of the present invention, to the tire carrier of the vehicle.

In some versions of the present invention, an auxiliary tab is connected to the cylinder as well. The auxiliary tab has an opening to mount radio antennae, trail flag, or other auxiliary.

The arrangement of elements and the composition of components facilitates use of the flag mount assembly, reduces cost of manufacture of the flag mount assembly, improves rigidity and durability of the flag mount assembly, and limits the potential for damaging contact between the flag mount assembly and the vehicle.

### BRIEF DESCRIPTION OF THE DRAWINGS

FIG. 1 is a perspective exploded view of a flag mount assembly;

FIG. 2 is a side plan view of a flag mount assembly;

FIG. 3 is a top plan view of a flag mount assembly; and

FIG. 4 is a perspective view of a flag mount assembly.

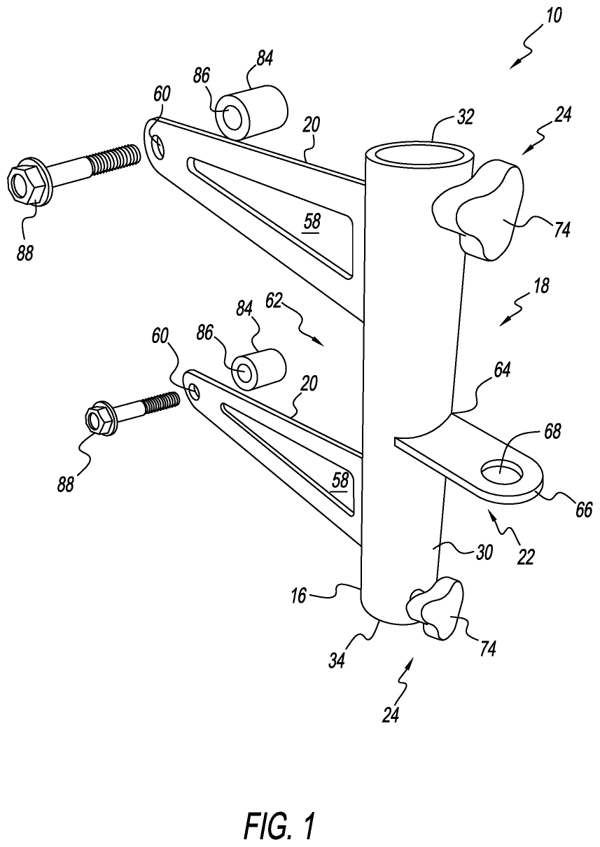

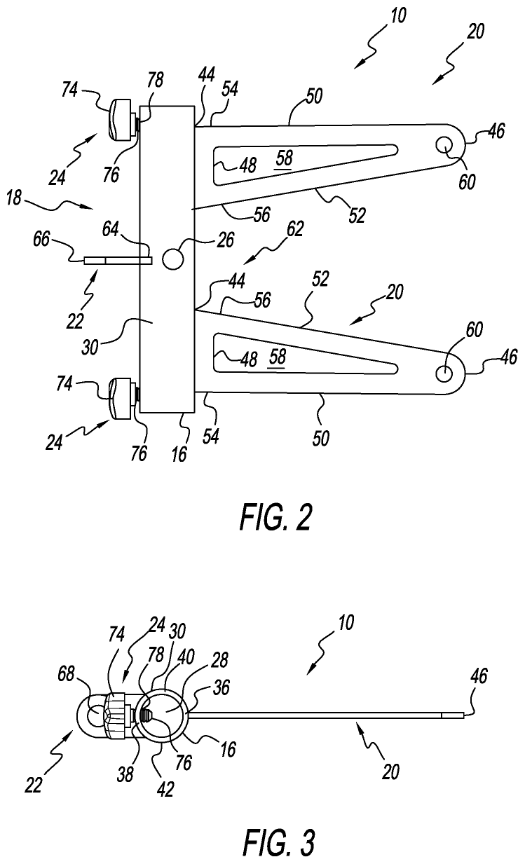

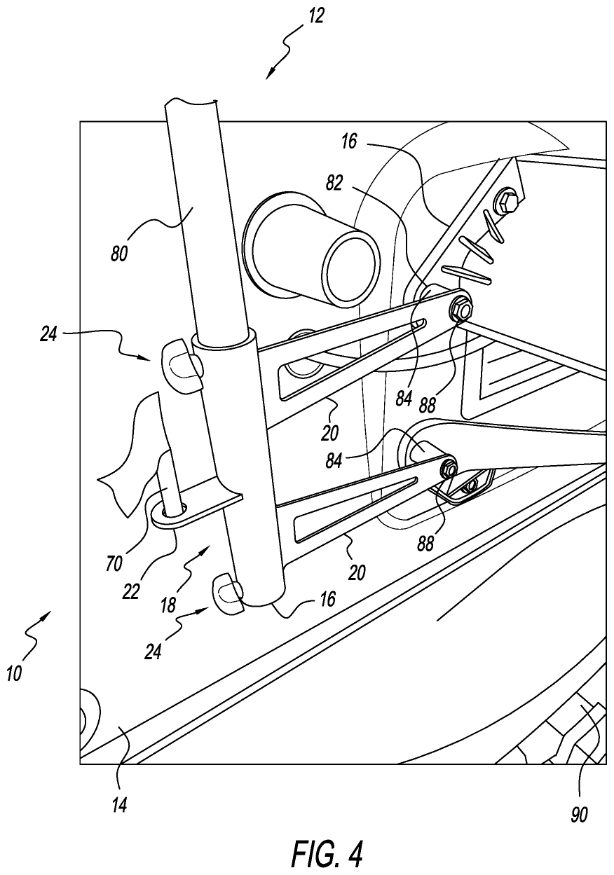

### DETAILED DESCRIPTION

With reference to the Figures a flag mount assembly 10 to mount a flag 12, such as a conventional American flag, to a vehicle 14 and particularly a vehicle 14 having a tire carrier 16 that is present already, such as sports utility vehicles (SUVs), such as the Jeep® Wrangler JL or JK, and sports activity vehicles (SAVs) or ATV All Terrain Vehicle. The flag mount assembly 10 has a tube or cylinder 18 that connects or attaches to one or more vehicle mounting brackets 20, which mount to the tire carrier 16 or other component of the vehicle 14. In some embodiments, the flag mount assembly 10 further comprises one or more of an auxiliary mount or tab 22, one or more flag securing members 24, and one or more bumper stops 26. Each of the preceding with be addressed in greater detail in the following including additional aspects of the present invention.

The cylinder 18 has a hollow interior 28 formed by a continuous sidewall 30 that extends from a first open end 32 to a second open end 34 with the hollow interior 28 extending therebetween. In some embodiments of the present invention, the hollow interior 28 has a diameter of 0.75 to 1.0 inch in between the continuous sidewall 30. Generally, the continuous sidewall 30 has a first side 36 diametrically opposed a second side 38 and a third side 40 centrally positioned between the first side 36 and second side 38 and diametrically opposed to a fourth side 42.

As shown in the exemplary embodiment of the Figures, the flag mount assembly 10 has two vehicle mounting brackets 20 attached to the cylinder 18. Although the present invention contemplates one or more vehicle mounting brackets 20, as described further herein, two vehicle mounting brackets 20 provides superior rigidity over a single vehicle mounting bracket 20 while avoiding excess weight, increased manufacturing, and difficulty of use related to greater numbers of vehicle mounting brackets 20. In some embodiments the cylinder 18 and the vehicle mounting brackets 20 are monolithically constructed either through molding or fabrication, such as welding, which increases durability and limits the points of fault in the flag mount assembly 10. To further increase durability and rigidity, the cylinder 18 and vehicle mounting brackets 20 are made of ⅛ inch steel and in still further embodiments are also powder coated.

Each vehicle mounting bracket 20 extends from a first end 44 abutting the cylinder 18 to a second end 46 away from the cylinder 18. In some arrangements of the present invention, the vehicle mounting bracket 20 is comprised of a vertical member 48, a horizontal member 50, and an angled member 52. In such embodiments, the vertical member 48 extends in parallel relation to the cylinder 18 between a first end 54 and a second end 56. The horizontal member 50 in some of these arrangements extends from the first end 54 of the vertical member 48 to the second end 46 of the vehicle mounting bracket 20. In this arrangement, the horizontal member 50 extends perpendicularly or substantially perpendicularly to the cylinder 18 and the vertical member 48. The angled member 52, in some such arrangements, extends at an angle between the second end 56 of the vertical member 48 and the second end 46 of the vehicle mounting bracket 20 that is neither parallel nor perpendicular to the vertical member 48 or horizontal member 50.

As depicted in the Figures, the arrangement of the vertical member 48, the horizontal member 50, and the angled member 52 form a triangular shape and in some embodiments a right triangle. Also shown in the Figures is that in some embodiments of the present invention, a gap or open region 58 is centrally positioned within the vehicle mounting bracket 20 that also has a triangular or right triangular shape. The configuration of the vehicle mounting bracket 20 enhances the durability and the rigidity of the flag mount assembly 10 thereby making it possible to hold larger flags 12 than conventional flag mount assemblies discussed previously. When present, the open region 58 further reduces the weight and manufacturing costs of the flag mount assembly 10. In some embodiments, including the exemplary embodiment, the second end 46 of the vehicle mounting bracket 20 is rounded so as to improve the aesthetic of the flag mount assembly 10 while also limiting potential harm caused if the second end 46 were inadvertently struck by an individual or surface.

In some embodiments of the present invention, the vehicle mounting bracket 20 has a flat, planar profile such that the profile of the vehicle mounting bracket 20 extends along a single, vertical plane, which in some embodiments this vertical plane also extends in the same relation as that between the first open end 32 and second open end 34 of the cylinder 18. In such arrangements, the flat, planar profile provides improved rigidity while lowering the weight of the vehicle mounting brackets as well as the overall size of the flag mount assembly 10 that in turn reduces cost and manufacturing demands.

Positioned adjacent the second end 46 of the vehicle mounting bracket 20 where the horizontal member 50 and the angled member 52 converge is an aperture or opening 60. The opening 60 is circular in some embodiments.

Although different configurations and number of vehicle mounting brackets 20 is contemplated, in some embodiments having two vehicle mounting brackets 20, the vehicle mountings brackets 20 are positioned along the same or substantially the same vertical plane and are arranged such that the vehicle mounting brackets 20 mirror each other. In some arrangements having two vehicle mounting brackets 20, including the exemplary embodiments of the Figures, the first vehicle mounting bracket 20A is positioned adjacent to or closer to the first open end 32 of the cylinder 18 and the second vehicle mounting bracket 20B is positioned adjacent or closer to the second open end 34 of the cylinder 18. In this configuration, the proximity to the first open end 32 and the second open end 34 increases the overall rigidity of the flag mount assembly 10 when compared to arrangements that position the vehicle mounting brackets 20 further from the first open end 32 and the second open end 34 and closer to a central point or region 62 of the cylinder 18. Also seen in the exemplary embodiments of the Figures, when the first vehicle mounting bracket 20A mirrors the second vehicle mounting bracket 20B, the respective angled members 52 are closer to one another than the respective horizontal members 50. Additionally, the respective angled member 52 extend away from each other the further each angled member 52 extends from the respective vertical member 48. In this arrangement, the opening 60 through and near the second end 46 each of the vehicle mounting brackets 20 are in alignment with one another along the same plane.

As seen in the exemplary embodiments, the vehicle mounting brackets 20 are positioned on the first side 36 of the cylinder 18 and the auxiliary tab 22 is positioned on the second side 38 of the cylinder 18 opposite the vehicle mounting brackets 20. The auxiliary tab 22 extends from a first end 64 abutting the cylinder 18 to a second end 66 away from the cylinder 18 and away from the one or more vehicle mounting brackets 20. In some embodiments, the second end 66 is rounded so as to improve the aesthetic of the flag mount assembly 10 while also limiting potential harm caused if the second end 66 were inadvertently struck by an individual or surface.

In some embodiments, the auxiliary tab 22 is positioned in the central region 62 of the cylinder 18 but in other arrangements can be positioned anywhere between the first open end 32 and the second open end 34 of the cylinder 18. The position of the auxiliary tab 22 in the central region 62 limits interference with the one or more flag securing members 24 described further below. Adjacent the second end 66 of the auxiliary tab 22 is an aperture or opening 68. The opening 68 is circular in some embodiments. The opening 68 is configured to receive an auxiliary 70 such as a trail flag or a citizens band radio (CB) antenna. The position of the opening 68 near the second end 66 further distances the auxiliary 70 from the tire carrier 16, making the auxiliary 70 more readily visible when a tire 72 (not shown) is mounted to the tire carrier 16. In some embodiments the cylinder 18 and the auxiliary tab 22 are monolithically constructed either through molding or fabrication, such as welding, which increases durability and limits the points of fault in the flag mount assembly 10. To further increase durability and rigidity, the cylinder 18 and auxiliary tab 22 are made of ⅛ inch steel and in still further embodiments are also powder coated.

The auxiliary tab 22, in some embodiments, has a flat, planar profile, such that the profile of the auxiliary tab extends along a single, horizontal plane, which in some embodiments, the horizontal plane extends in perpendicular relationship to that of the vertical plane extending through the one or more vehicle mounting members 20. In such arrangements, the flat, planar profile provides improved rigidity while lowering the weight of the vehicle mount brackets as well as the overall size of the flag mount assembly 10 that in turn reduces cost and manufacturing demands.

One or more flag securing members 24 are removably or selectively attached to the cylinder 18. As shown in the examples of the present invention depicted in the Figures, the two flag securing members 24 are received on the second side 38 of the cylinder 18. In other arrangements one or more than two flag securing members 24 are present and depending on the embodiment can be positioned in any location or locations on the cylinder 18. Positioning the flag securing members 24 on the same side of the cylinder 18 as the auxiliary tab 22 provides for an improved aesthetic as the cylinder 18 can be left without attachment on the third side 40, fourth side 42, or both. Additionally, when operation of the flag securing members 24 is more easily accomplished by an individual when positioned on the second side 38 as described further herein.

In some embodiments of the present invention, each flag securing member 24 has a knob 74 that is connected to a shaft 76, which is threaded in some arrangements. The knob 74 in some embodiments is ribbed to facilitate gripping and using of the knob 74. The shaft 76 is removably received within a hole or opening 78 in the cylinder 18. In embodiments with a threaded shaft 76, the knob 74 is rotated to either increase or reduce the depth by which the shaft 76 extends into the hollow interior 28 of the cylinder 18. When a flag 12 is inserted into the cylinder 18 a flag pole 80 of the flag 12 may vary in length and diameter. While the flag pole 80 is inserted within the hollow interior 28 the flag securing member 24 is selectively inserted into the hollow interior 28 to engage the flag pole 80 and apply pressure to the flag pole 80 between the shaft 76 of the flag securing member 24 and the continuous sidewall 30 of the cylinder 18 such that the flag pole 80 is held in place and the flag 12 can be selectively positioned.

As seen in the exemplary embodiments of the Figures, some arrangements of the present invention have a first flag securing member 24A positioned adjacent the first open end 32 of the cylinder 18 and a second flag securing member 24B adjacent the second open end 34 of the cylinder 18. This permits the flag mount assembly 10 to have identical operation when in reversed positions as described further below, but also allows a short flag pole 80 to be secured by the first flag securing member 24A even if the flag pole 80 does not reach the second flag securing member 24B. When a larger and longer flag pole 80 is present, both the first flag securing member 24A and second flag securing member 24B can engage and secure the flag pole 80.

In some embodiments, the third side 40, the fourth side 42, or both have one or more bumper stops 26. In still other arrangements, the one or more bumper stops are positioned in any location or locations on the cylinder 18, including near the first open end 32, second open end 34, or the central region 62, that prevent contact between the cylinder 18 and the vehicle 14 as described further in the following. As shown in the exemplary embodiment, the bumper stop 26 is positioned on the third side 40 within the central region 62, which provides superior impact reduction as described further herein as other locations could result in a portion of the cylinder 18 furthest from the bumper stop 26 contacting the vehicle 14 and causing damage. The bumper stop 26 can be of any shape and size. The bumper stop 26 in some embodiments is cylindrical in shape and extends outwardly and away from the cylinder 18. In this way, the bumper stop 26 prevents the cylinder 18 from engaging the vehicle 14 when the flag mount assembly 10 is mounted to the vehicle 14 because the bumper stop 26 is positioned between the flag mount assembly 10 and the vehicle 14. In some embodiments, the bumper stop 26 is made of or covered by an impact force reducing material such as rubber.

In operation, an individual removes the tire 72 from the tire carrier 16 of the vehicle 14. The opening 60 of each vehicle mounting bracket 20 is aligned with an opening 82 in the tire carrier 16. In some embodiments, a spacer 84 having an opening 86 therethrough is positioned between the tire carrier 16 and the vehicle mounting bracket 20. A securing member 88, such as a bolt, is passed through the opening 60 of the vehicle mounting bracket 20 (and the spacer 84 when present) and into the opening 82 of the tire carrier 16. The securing member 88 is then secured or fastened such that the flag mount assembly 10 is fixed or substantially fixed in relation to the vehicle 14. The spacer 84, when present, distances the cylinder 18 and the one or more vehicle mounting brackets 20 away from the vehicle 14 so as to prevent contact that between the two that could damage the vehicle 14 or the flag mount assembly 10. The presence of the bumper stop 26 further inhibits contact from occurring.

The flag pole 80 is then inserted into the hollow interior 28 of the cylinder 18 to a position selected by the individual. The one or more flag securing members 24 are then selectively fastened to secure the position of the flag pole 80 and thus the flag 12. As described previously, the exemplary embodiment positions the first flag securing member 24A and the second flag securing member 24B on the second side 38 and adjacent the first open end 32 and second open end 34, respectively. In this arrangement, the individual can more easily hold the flag pole 80 in the selected position with one hand while using the other hand to rotate the knob 74 in a natural way either towards or away from the individual. Although other arrangements are contemplated, it is apparent that such arrangements would cause an individual to turn the knob 74 in an unnatural way to the left or right with one hand while holding the flag pole 80 in an overlapping fashion with the flag securing member 24, which would be more difficult. The individual can then insert an auxiliary 70 into the opening 68 of the auxiliary tab 22.

Thereafter, the tire 72 is again mounted to the tire carrier 16. When fully assembled, the flag mount assembly 10 is partially obscured by the tire 72 mounted to the tire carrier 16 thereby diminishing any aesthetic detriment caused by the flag mount assembly 10. The rear of the vehicle 14 is still operational and can be opened without interference by the flag mount assembly 10 and a hitch 90 of the vehicle 14 is also free from encumbrance.

The arrangement of the one or more vehicle mounting brackets 20, the auxiliary tab 22, and the one or more flag securing members 24 described in relationship to the exemplary embodiment of the Figures allows the flag mount assembly 10 to be connected to the tire carrier 16 on either the driver side or passenger side in identical, mirror arrangement such that the only distinction between the two positions is the direction that the vehicle mounting brackets 20, the auxiliary tab 22, and the flag securing members 24 extend. Accordingly, the arrangement of the present invention permits a single flag mount assembly 10 to be manufactured that works in nearly identical operation on both the driver side and passenger side of the vehicle 14 and permits the attachment of two of the flag mount assembly 10 to be attached to the vehicle 14 at the same time.

Therefore, a flag mount assembly 10 and system has been provided that can mount and present a conventionally sized flag, permits multiple flags to be presented, permits flags to be selectively presented on either a driver's side or a passenger's side of a vehicle, is reversible, is durable, is easy to use, and improves upon the art.

From the above discussion and accompanying figures and claims it will be appreciated that the flag mount assembly 10 and system offers many advantages over the prior art. It will be appreciated further by those skilled in the art that various other modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

What is claimed is:

1. A flag mount assembly comprising:
a cylinder having a hollow interior;
a first vehicle mounting bracket attached to the cylinder;
a first flag securing member selectively received in the cylinder; and
wherein the first vehicle mounting bracket is configured to mount to a vehicle.

2. The flag mount assembly of claim 1 further comprising an auxiliary tab attached to the cylinder.

3. The flag mount assembly of claim 1 further comprising a bumper stop attached to the cylinder.

4. The flag mount assembly of claim 1 further comprising the first vehicle mounting bracket having a right triangular profile.

5. The flag mount assembly of claim 1 further comprising the first vehicle mounting bracket having an open region and an opening, wherein the opening receives a securing member.

6. The flag mount assembly of claim 1 further comprising a second vehicle mounting bracket attached to the cylinder.

7. The flag mount assembly of claim 6 wherein the first vehicle mounting bracket and the second vehicle mounting bracket are positioned in alignment with one another along a vertical plane.

8. The flag mount assembly of claim 6 wherein the first vehicle mounting bracket and the second vehicle mounting bracket each have a flat profile.

9. The flag mount assembly of claim 1 wherein the first vehicle mounting bracket is configured to mount to a tire carrier of the vehicle.

10. The flag mount assembly of claim 1 further comprising a second flag securing member selectively received in the cylinder.

11. The flag mount assembly of claim 1 further comprising a spacer connected to the first vehicle mounting bracket.

12. A flag mount assembly comprising:
a cylinder having a hollow interior, wherein the cylinder is formed by a continuous sidewall that extends from a first open end to a second open end;
a first vehicle mounting bracket and a second vehicle mounting bracket attached to the cylinder on a first side of the cylinder;
a first flag securing member selectively received in the cylinder on a second side of the cylinder; and
wherein the first vehicle mounting bracket and the second vehicle mounting bracket are configured to mount to a vehicle.

13. The flag mount assembly of claim 12 wherein the first vehicle mounting bracket and the second vehicle mounting bracket each extend from a first end abutting the cylinder to a second end positioned away from the cylinder, and an opening is positioned adjacent the second end.

14. The flag mount assembly of claim 13 wherein the first vehicle mounting bracket and the second vehicle mounting bracket each comprise a vertical member that extends in parallel relation with the cylinder between the first open end and the second open end, a horizontal member that extends from the first end to the second end in substantially perpendicular relation to the cylinder, and an angled member that extends from the second end of the vertical member to the second end of the first vehicle mounting bracket.

15. The flag mount assembly of claim 14 further comprising the vertical member, the horizontal member, and the angled member forming a centrally located open region within each of the first vehicle mounting bracket and the second vehicle mounting bracket.

16. The flag mount assembly of claim 14 wherein the first vehicle mounting bracket and the second vehicle mounting bracket mirror each other.

17. The flag mount assembly of claim 14 wherein the first vehicle mounting bracket and the second vehicle mounting bracket each have a flat, planar profile such that each of the angled member of the first vehicle mounting bracket and the second vehicle mounting bracket extend away from each other.

18. The flag mount assembly of claim 12 further comprising an auxiliary tab connected to the cylinder and having an opening that is configured to receive an auxiliary.

19. The flag mount assembly of claim 12 further comprising a spacer connected to the first vehicle mounting bracket.
